(19) United States
(12) Patent Application Publication
(10) Pub. No.: US 2005/0142266 A1
(43) Pub. Date: Jun. 30, 2005

(54) Process and an equipment for the rapid preparation of italian-style pasta dishes

(76) Inventors: Sergio Veronesi, Basilicanova (IT); Sergio Comito Viola, Sant'Ilario d'Enza (IT)

Correspondence Address: MCDERMOTT, WILL & EMERY, 600 13th Street, N.W., Washington, DC, 20005-3096, US

(21) Appl. No.: 10/744,077

(22) Filed: Dec. 24, 2003

(51) Int. Cl. A23L 1/00

(52) U.S. Cl. 426/506

(57) ABSTRACT

A process is described for the preparation of “fastfood” Italian-style pasta dishes that comprises the steps of a) providing single-dose portions of frozen pre-cooked pasta, and sauces or flavorings maintained at 0°-4° C.; b) immersing the portions of frozen pre-cooked pasta in water maintained at a constant temperature of 96-99° C. for 20-30 seconds; c) pouring a pre-measured amount of sauce or flavoring into a container suitable to be put onto a stove top, and transferring the container onto the stove top to heat the sauce or flavoring; d) draining the pasta portion and adding it to the sauce or flavoring in the container on the stove top and amalgamating, over the heat, the pasta with the sauce or flavoring; the above process is carried out using an equipment comprising a thermostated water bath, a stove top and means for maintaining the sauce or flavoring at 0°-4° C.

### FIELD OF APPLICATION

The present invention relates, in general, to the sector of foodstuff industry, and particularly concerns a process for the rapid preparation of Italian-style pasta dishes in single portions and the equipment to carry out the said process.

The Italian-style pasta dish is one of the pillars of the “Mediterranean” diet that has had continuously increasing success in all European and North American countries for its recognized beneficial effects on health.

An inconvenience of Italian-style pasta dishes, felt especially in northern European and North American countries, is the quite long preparation time that makes it difficult to organize “fast food” catering based on pasta with a service rate analogous to that at sales and eating points of the hamburger, hot dog and the like.

### STATE OF THE ART

A tentative to overcome the said inconvenience is the equipment described in patent application EP 1 219 213, that permits the preparation of portions of Italian-style pasta in limited times. Such equipment essentially comprises an automatic pasta-cooker, a stove top and some means of heating or keeping sauces or flavorings warm.

The said equipment can be used to prepare a plate of pasta in just a few minutes, cooking a pre-determined form of pasta in the automatic pasta-cooker, transferring the cooked pasta to a pan on the stove top, adding the hot sauce and sauteing the whole.

The process carried out using the equipment according to the said application has some inconveniences. First of all the preparation time of the pasta dish is still incompatible with that of a true and proper “fast food” service that calls for times in the order of a fraction of a minute.

When different pasta forms are used an adjustment must be made to the cooking times of the automatic pasta cooker, altering them in accordance with the thickness of the pasta, and this can cause problems in cases where—as often happens in fast food restaurants—the personnel assigned the task of preparing the dishes have no particular training and are not specialized.

Furthermore the means used in the said process for heating the sauces or flavorings, or keeping them warm, lead to progressive deterioration in the nutritional and organoleptic characteristics of the sauces and flavorings.

### SUMMARY OF THE INVENTION

The problem underlying the present invention has, therefore, been to make a process available for the preparation of portions of Italian-style pasta with a serving speed comparable to that of the usual “fast food” for hamburgers, hot dogs and the like, that does not call for any adjustment to be made on the part of the personnel doing the cooking and that supplies a product with better nutritional and organoleptic characteristics.

Such a problem has been resolved, according to the invention, by a process for preparing Italian-style pasta dishes that comprises the steps of:
a) providing single-dose portions of pre-cooked and frozen pasta;
b) providing at least one sauce or flavoring, maintained cold at a temperature of 0°-4° C.;
c) immersing at least one single-dose portion of frozen pre-cooked pasta for 20-30 seconds in water kept at a constant temperature of 96-99° C.;
d) pouring into a container suitable to be placed on a stove top a pre-measured quantity of said cold sauce or flavoring, and transferring the container onto the stove top to heat the sauce or flavoring.
e) draining said at least one single-dose pasta portion and adding it to the sauce or flavoring in the said container on the stove top and, over the heat, mixing the pasta portion with said sauce or flavoring.

Note the fact that, in the present invention, the immersion time of the frozen pre-cooked pasta in the hot water does not change with the variation in pasta shape and thickness because the starting pasta, before being frozen, was cooked to the optimal level, and the immersion in water at 96-99° C. has the sole aim of taking it to the optimal temperature for mixing, over heat, with the sauce.

For this reason the process according to the present invention can be carried out with success even by personnel not particularly trained or expert in the sector, like those normally in service at fast food chains.

Furthermore, the use of sauces or flavorings maintained under refrigeration (0°-4° C.) results in dressed pasta dishes with nutritional and organoleptic properties that are substantially unaltered over the course of a whole day, whereas the sauces and flavorings heated by the known technique manifest progressive alteration of their nutritional and organoleptic characteristics as well as of consistency.

The pre-cooked and frozen pasta starting material is preferably pre-salted so that the cooking is done in water that is not salted. In this way possible errors in salting the cooking water, that could worsen the organoleptic properties of the final pasta dish, are avoided.

The frozen pre-cooked pasta can have the form of a “small brick” of predetermined weight or volume, in which single elements (e.g. spaghetti or macaroni) are clustered together, or else it can be frozen pre-cooked pasta IQF, in which the single elements are loose. In this last case the dosage of the single portions can be volumetric by means of a measuring container or based on weight.

To carry out the above illustrated process, the present invention foresees the use of equipment consisting of a thermostated water bath, a stove top and a means of maintaining the sauce or flavoring at a temperature of 0°-4° C.

Preferably, the thermostated water bath consists of a cooking vessel, a plurality of baskets suitable for containing the frozen pre-cooked pasta and a device for heating the water to a pre-established value varying between 96 and 99° C., wherein the heating device is regulated to become activated when the temperature drops to as little as 0.1° C. below the pre-established value, so as to return the temperature immediately to this value.

The device for heating the water is conveniently an electrical resistance type and has 2.5-4.0 kW power per each basket, preferably 3.0 kW per each basket. The water temperature inside the cooking container is continuously monitored by means of an immersed probe that sends a corresponding electrical signal to a thermoregulator that has an intervention differential of 0.1° C.

Advantageously, the thermostated water bath that is part of the equipment according to the present invention is provided with a means for the input of water into the vessel, this being connected to a water system or reservoirs for this purpose, as well as means, at the bottom of the vessel, to drain water from it.

The water level within the vessel is maintained substantially constant by means of a probe that detects the maximum and minimum water levels within the vessel. Any momentary drop below the pre-established minimum level within the vessel is detected by the probe and immediately thereafter transmitted to a PLC control unit, that orders the automatic release of a pre-established amount of water into the vessel.

In addition a safety probe is positioned near the bottom of the thermostated water bath. In the event that the water contained in the vessel drops to below the level of the safety probe position because of malfunction in the water level measurement probe, the safety probe sends a signal of immediate shutdown to the control unit of the equipment.

The control unit comprises said thermoregulator that receives the signals from the probe measuring the water temperature and triggers the heating device the moment the temperature drops 0.1° C. below the pre-established temperature.

The apparatus according to the invention comprises, in addition to the control PLC unit, a keyboard for laying down the processing parameters. Advantageously, once the apparatus starts working the electronic card inserted into the control unit completely disables the keyboard until the operations in progress are terminated.

This avoids little experienced personnel accidentally modifying the pre-imposed parameters of the system, that would compromise the final result of the process according to the invention.

The keyboard can be enabled only by the prior insertion of an appropriate code, known only to specialized personnel authorized to modify the parameters of the system.

The keyboard can, furthermore, include one or more keys, freely actionable by personnel assigned to the preparation of the dishes, that determine a pre-established prolongation of the cooking time in the case where there is the preparation of dishes of filled pasta forms e.g. tortellini or ravioli.

The present invention will be further described making reference to the drawings supplied in the following as illustrative and not limiting.

### BRIEF DESCRIPTION OF THE DRAWINGS

FIG. 1 shows, in a schematic way, a part of an equipment to carry out the process according to the present invention.

FIG. 2 represents the instructions supplied on a monitor to an operator for the execution of the process according to the invention.

### DETAILED DESCRIPTION OF THE INVENTION

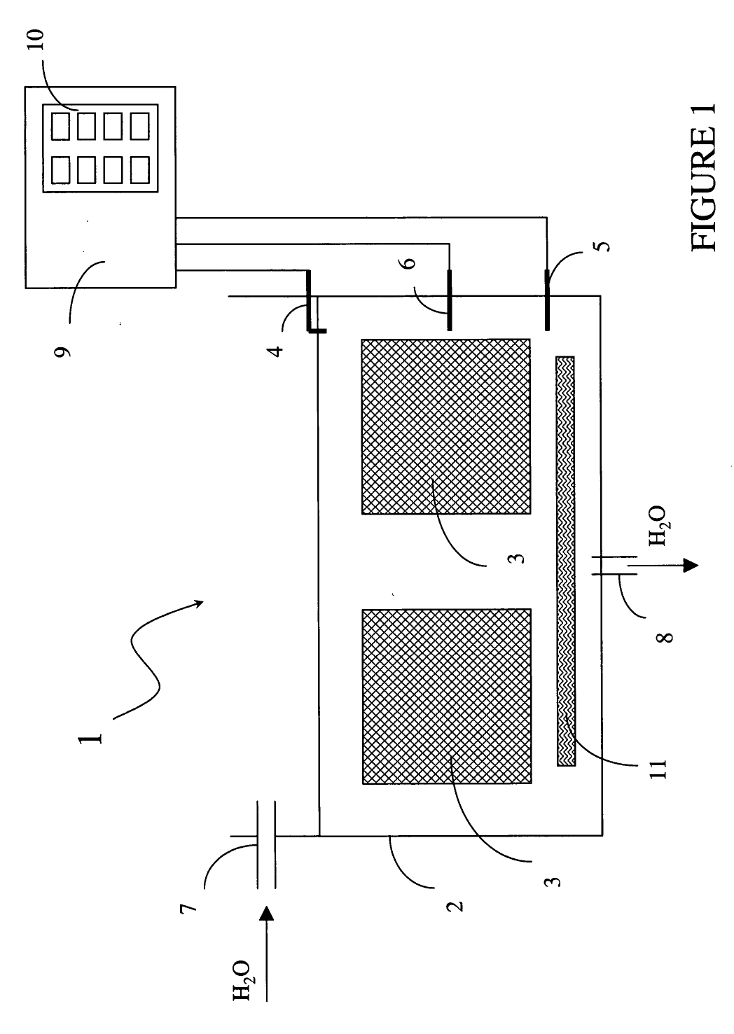

In FIG. 1 there is the scheme of a thermostated water bath, indicated generally by 1, that includes a vessel 2, generally of stainless steel, filled with water to a predetermined level and a pair of baskets 3, also these generally in stainless steel, possibly covered with Teflon, for receiving frozen pre-cooked pasta portions with a predetermined weight or volume.

In vessel 2 there are arranged a probe 4 to measure the water level contained in vessel 2, and a safety probe 5 lying close to the bottom of vessel 2.

In vessel 2 there is also located a third probe 6 that measures the temperature of the water in vessel 2.

Near the bottom of vessel 2 there is a device 11 for heating the water, consisting of an electrical resistance. In an alternative implementation and not depicted, vessel 2 can be a type with a double wall and the heating device 11 can be in the gap between the two walls.

Finally in the upper part of vessel 2 there is a means for water input 7, connected to the water system or to a water reservoir for this purpose, and a drainage outlet 8 for water settled at the bottom of vessel 2.

Probes 4, 5 and 6 are connected electrically to a control unit PLC 9, including a command keyboard 10.

The apparatus further includes another two components, not shown in that they are conventional, consisting of a stove top and a means for maintaining the sauce or flavoring at a temperature of 0-4° C.

The stove top can consist of one or more electric, infrared or induction hotplates or of one or more gas burners.

The means for maintaining the sauce or flavoring at what is, essentially, refrigeration temperature can consist of cooling devices applied to containers e.g. to small tubs or bowls containing the sauce or flavoring. Such cooling devices can be serpentine coils through which a cooling fluid flows or else double-walled containers with the gap between the two walls containing a refrigerating liquid, which containers have been previously cooled in a freezer.

It is convenient to complete the equipment according to the invention by having a freezer to store the portions of frozen pre-cooked pasta.

The description given here of the equipment according to the present invention is absolutely schematic, and makes no reference to construction details known for some years in the sector of machines for cooking pasta and that can find applications also in the present case.

For example, automatism can be foreseen for loading the pasta into the baskets, for immersing it into the water and for the following steps of draining and pouring into containers, typically pans, for transfer to the stove top. Such pans can also be of the disposable type.

It is advantageous to set the stove top next to the thermostated water bath 2, at the discharge or emptying position of the baskets 3, so that the cooked pasta is discharged directly into the pan sitting on the stove top.

Other constructive solutions already known in the technique and that can be applied also to the present invention are represented, for example, by means for condensing the steam emitted by the water bath and returning it to the vessel, exhaust hoods etc.

The number of baskets can vary at will from 1 to 4 or even more, according to production needs.

Using the above described equipment, a non limiting embodiment of the process according to the invention can be described as follows.

The equipment according to the invention is first of all started up by acting on the keyboard 10 of the control unit 9 that provides for the input of water into vessel 2 through the input means 7 connected to the water system or the reservoir. The water inflow is interrupted automatically as soon as probe 4 measures the water level as having reached the maximum. The control unit activates the heating device 11, having a power of 6 kW, that takes the temperature of the water within vessel 2 to 98° C. Immediately on reaching this temperature the portions—with predetermined weight or volume—of pasta of any form whatever (e.g. spaghetti, penne, rigatoni, etc.), previously cooked to the optimal point to give “al dente” consistency and then frozen, begin to be fed into the baskets that are automatically immersed in the water.

The contact of the frozen pasta with the hot water in the vessel tends to lower the temperature. The moment the temperature drops 0.1° C. below the pre-established value of 98° C., probe 6 sends a corresponding signal to the control unit 9, that immediately activates the heating device 11 so that the pre-established value is recovered almost instantly.

Thanks to this punctual and immediate control and the great power of the heating device 11, only about 30 seconds are needed to take the frozen pre-cooked pasta contained in the baskets 3 to a temperature (about 90° C.) suitable for the following preparation phases of the pasta dish according to the present process.

In the meantime the sauce maintained at 0°-4° C. is withdrawn in a measured quantity with an appropriate measuring ladle, and transferred to a pan that is placed on the stove top. As an alternative, if pre-packed single-dose sauce portions are used, one of these packets maintained at 0-4° C. is taken and the contents poured into the pan. In any case the heating of the sauce begins on the stove top that is situated at the discharge position of the baskets 3 of the thermostated water bath 2.

After 30 seconds immersion of the pasta in the thermostatted water bath, control unit 9 drives the removal of the baskets from vessel 2, the draining of the pasta and the deposition of the same in the pan containing the sauce, all by means of conventionally known automatism.

At this point there is the manual mixing of the pasta with the sauce, continuing to heat the pan on the stove top so as to carry out the “sauteing” in the pan and amalgamate the pasta with the sauce.

The pasta portion dressed with the sauce is now ready to be served and everything has taken place in a time absolutely compatible with the service rhythm of fast food restaurants.

When the apparatus is at running speed, using four baskets it is possible to prepare a plate of ready to serve pasta every 15 seconds.

The process and the apparatus according to the present invention allow, in addition, the obtaining of high standard Italian-style pasta dishes, characterized by the constancy of the “al dente” consistency as with sauce consistency that must be neither too liquid nor too dense. In fact it is well known that a too prolonged “saute” in the pan leads to a pasta dish with a too dense sauce, and the pasta is said to be “troppo asciutto” i.e. too dry, viceversa too short a “sautè” in the pan results in a pasta dish dressed with a sauce that is too watery.

To ensure the above mentioned high standard, the process according to the invention foresees a continuous monitoring of the times of the different preparation steps, obtained by instructing the operator by means of a display (a monitor) connected to a computer that carries out a program expressly developed for the handling of the said process.

The operator who must prepare the plate of pasta faces a monitor with a screen divided into two parts: on the right is the list of dishes to serve (various types of dressed pasta e.g. carbonara, amatriciana, etc.) and served, while the left shows the various operations to be carried out.

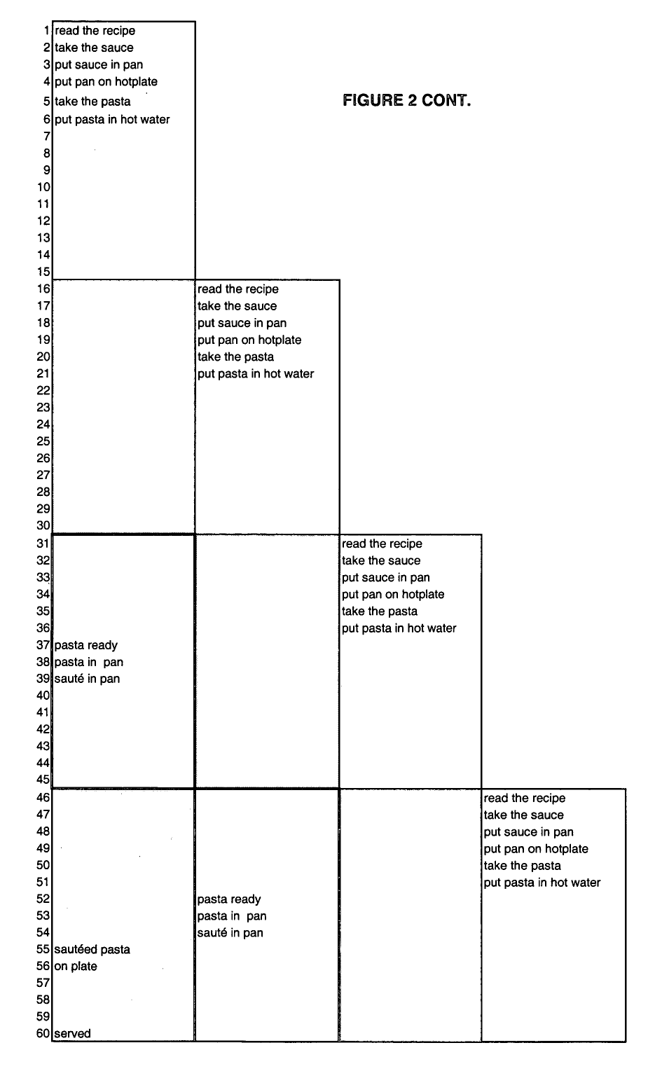

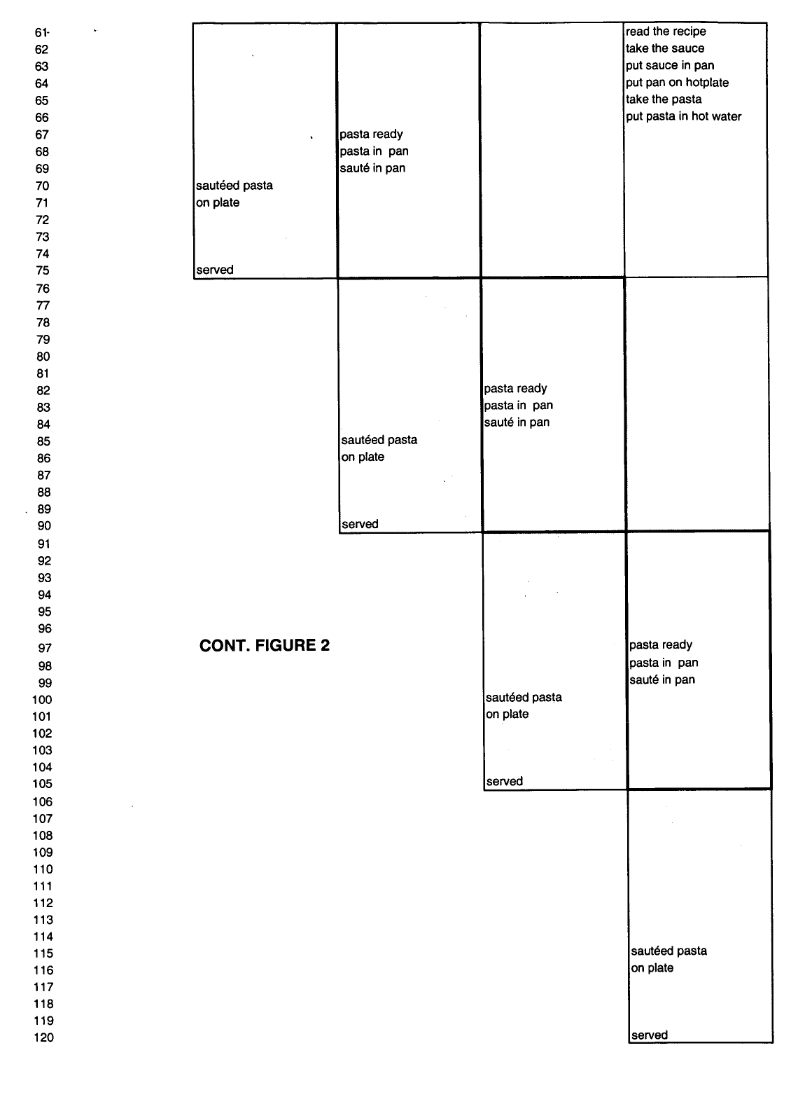

FIG. 2 shows the single screen in relation to the operations to be carried out when the equipment according to the invention foresees the use of four baskets to immerse the frozen pre-cooked pasta. With reference to this figure, the column most to the left refers to the time in seconds and the adjacent column gives the instructions for the preparation of the first pasta dish. The series of operations needed to serve a plate of Italian-style pasta with the process according to the invention is subdivided into four phases.

The operator, once having received the order for a given plate of pasta, carries out the reported operations in correspondence with times from 1 to 6 seconds, that is he reads the recipe and gives permission by pushing a button. Thus the first phase begins, in which the operator puts the sauce in a first pan, transfers the pan to the stove top, and puts the pasta into a first basket and into the thermostated water bath.

For the sake of convenience, the stove top of the equipment according to the invention comprises four hotplates or four similar means of heating, and the operator transfers the pan onto a first of these.

At this point, the operator waits until time t=16 seconds before repeating the operations of the above first phase for the preparation of the second plate of pasta, putting the pasta into a second basket of the thermostated water bath and the sauce into a second pan./

In the meantime the preparation of the first pasta dish is in the second phase (dark gray rectangle), that is only a waiting phase.

Before transferring the second pan with the sauce onto the stove top, the operator conveniently transfers the first pan onto the second hotplate and puts the second pan onto the first.

At time t=31 seconds, the operator begins the preparation of the third plate of pasta, repeating the operations of the above first phase, always with the foresight of placing the third pan on the first hotplate, moving the second pan onto the second hotplate after having transferred the first pan onto the third hotplate.

In the meantime there begins the second phase for the second plate of pasta and a third phase for the first plate of pasta (white rectangle with thick borders).

In the third phase, at time t=37 seconds, the pasta in the first basket is transferred to the first pan that is on the third hotplate where it is sautéed.

At time t=46 seconds, the operator begins the first phase of the preparation of the fourth plate of pasta, putting the frozen pre-cooked pasta into the fourth basket and the sauce into a fourth pan, that is placed on the first hotplate, moving the third, second and first pans respectively onto the second, third and fourth hotplates.

In the meantime the third phase begins for the second plate of pasta and the fourth phase for the first plate of pasta (light gray rectangle).

In the said third phase of the second plate, at time t=52 seconds, the pasta of the second basket is transferred into the second pan for sauteing.

In the fourth phase of the first plate, at time t=55 seconds, the pasta in the first pan is ready to be transferred to the dish and served, the whole operation being concluded within 60 seconds of the beginning.

As noted from FIG. 2, at intervals of 15 seconds one from the other also the servings of the remaining pans become ready and from then onwards the process is in continuous running, permitting the preparation of four servings of Italian-style pasta per minute with absolutely constant consistency characteristics with regard to both the pasta and the sauce.

Furthermore a constant serving temperature is obtained for the pasta dishes, that always have a temperature of more than 65° C.

1. A Process for the preparation of Italian-style pasta dishes, comprising the steps of:
a) providing single-dose portions of frozen pre-cooked pasta;
b) providing at least one sauce or flavoring, kept cold at a temperature of 0°-4° C.;
c) immersing at least one of said portions of frozen pre-cooked pasta in water maintained constantly at a temperature of 96-99° C. for a predetermined time of 20-30 seconds;
d) pouring a pre-measured quantity of said cold sauce or flavoring into a container suitable to be placed on a stove top, and transferring the container onto a stove top to heat the sauce or flavoring;
e) draining said at least one portion of pasta and adding it to the sauce or flavoring contained in said container placed on the stove top and amalgamating, over the heat, the pasta with said sauce or flavoring.

2. A process according to claim 1, wherein said immersion step of the frozen pre-cooked pasta is carried out in a thermostated water bath comprising a cooking vessel, a number of baskets suitable to contain the frozen pre-cooked pasta, a device for heating the water to a pre-established value varying between 96 and 99° C., said heating device being regulated in such a way to be triggered as soon as the temperature drops 0.1° C. below said pre-established value, so as to bring back immediately the temperature to said value.

3. A process according to claim 2, wherein said device for heating the water is of the electric resistance type with a power of 2.5-4.0 kW per each basket and is regulated by a control unit.

4. A process according to claim 3, wherein which the temperature of the water inside the vessel is continuously monitored by a first immersed probe, that sends a corresponding electric signal to a thermoregulator with a differential intervention of 0.1° C., located in the control unit.

5. A process according to claim 1, wherein said frozen pre-cooked pasta is pre-salted.

6. An equipment to carry out the process according to claim 1 comprising a thermostated water bath, a stove top and a means to keep the sauce or flavoring at a temperature of 0°-4° C.

7. An equipment according to claim 6, wherein said thermostated water bath comprises a cooking vessel, a plurality of baskets for containing frozen pre-cooked pasta, a device for heating the water to a pre-established temperature varying between 96 and 99° C., said heating device being regulated in such a way as to be triggered as soon as the temperature drops 0.1° C. below the pre-established value, so that the temperature returns immediately to the said value.

8. An equipment according to claim 7, wherein said device for heating the water is the electric resistance type and has a power of 2.5-4.0 kW per each basket.

9. An equipment according to claim 8, wherein said device for heating the water has a power of 3 kW per each basket.

10. An equipment according to claim 7, wherein said heating device is regulated by a control unit.

11. An equipment according to claim 10, wherein the temperature of the water in the vessel is continuously monitored by an immersed first probe that sends a corresponding electric signal to a thermoregulator with an intervention differential of 0.1° C. situated in the control unit.

12. An equipment according to claim 11, further comprising a second probe set inside in the upper part of the vessel, for detecting and signalling to the control unit the level of water contained in the vessel.

13. An equipment according to claim 12, further comprising a third probe set near the bottom of the vessel, that, in the event of the water in vessel dropping below a pre-determined minimum level, sends a signal to the control unit, following which there is the immediate shutting down of the equipment.

14. An equipment according to claim 13, further comprising means for the input of water into the vessel, situated in the upper part of the vessel and connected to the water system or to an appropriate reservoir, as well as means for draining water from the bottom of the vessel.

15. An equipment according to claim 7, wherein said thermostated water bath includes a device for automatically lifting out of water and emptying the baskets at the end of the pre-determined immersion time of the frozen pre-cooked pasta.

16. An equipment according to claim 15, wherein said stove top is set next to said thermostated water bath, at an emptying position of said baskets.

17. A process according to claim 1, wherein the operating times of said steps c), d) and e) are regulated and standardized by instructions, imparted to an operator charged with the task of carrying out the process, through visualization means connected to a computer.

18. A process according to claim 2, wherein said thermostated water bath includes four baskets and wherein the operation times of said steps c), d) and e) are regulated and standardized by instructions imparted to an operator charged with the task of carrying out the process, through visualization means connected to a computer, so as to permit the preparation of four plates of Italian-style pasta in a minute.
